(19) United States
(12) Patent Application Publication
(10) Pub. No.: US 2026/0129374 A1
(43) Pub. Date: May 7, 2026

(54) VEHICLE AUDIO SYSTEM

(71) Applicant: Jaguar Land Rover Limited, Coventry (GB)

(72) Inventors: Paul Wiles, Coventry (GB); Sam Soar, Coventry (GB)

(21) Appl. No.: 19/376,349

(22) Filed: Oct. 31, 2025

(30) Foreign Application Priority Data
Nov. 1, 2024 (GB) 2416145.7

(51) Int. Cl. H04R 19/02; H04R 1/02; H04R 3/12

(52) U.S. Cl. CPC H04R 19/02; H04R 1/025; H04R 3/12; H04R 2499/13

(57) ABSTRACT

Aspects of the present invention relate to a vehicle audio system for a vehicle comprising: at least one audio speaker for converting a speaker audio signal to sound waves; at least one electrostatic panel loudspeaker for converting a panel audio signal to sound waves; a control system in communication with the at least one audio speaker and the at least one electrostatic panel loudspeaker, and configured to cause the at least one audio speaker to convert the speaker audio signal to sound waves, and cause the at least one electrostatic panel loudspeaker to convert the panel audio signal to sound waves.

### CROSS-REFERENCE TO RELATED APPLICATIONS

This application claims priority to Great Britain Patent Application No. GB2416145.7, filed 1 November 2024, the entire contents of which are incorporated herein as if fully set forth below.

### TECHNICAL FIELD

The present disclosure relates to a vehicle audio system. Aspects of the invention relate to a vehicle audio system and to a vehicle.

### BACKGROUND

Audio systems in vehicles undergo periodic upgrades and improvement, particularly at the present time where there is a need to evolve and adapt vehicle audio system designs based on the ever-changing requirements of consumers as well as the vehicle industry as a whole.

For example, consumers desire improvements to be made in the sound quality of their vehicle audio systems. The demand for increasingly immersive and/or interactive experiences when listening to audio in their vehicles is also growing. Additionally, in recent years, there has been a drive to adopt an increasingly sustainable and eco-friendly approach to vehicle design, for example as can be seen from the rise in use of clean technologies, and the increased adoption of electric (or hybrid) vehicles.

It is desirable to be able to fit the most up-to-date and modern vehicle audio systems alongside existing designs of vehicle sound and power systems, so as to improve the audio experience for users and to avoid the costs associated with large-scale alterations of underlying vehicle design.

It is an aim of the present invention to address one or more of the disadvantages associated with the prior art.

### SUMMARY OF THE INVENTION

Aspects and embodiments of the invention provide a vehicle audio system and a vehicle as claimed in the appended claims.

According to an aspect of the present invention there is provided a vehicle audio system for a vehicle comprising: at least one audio speaker for converting a speaker audio signal to sound waves; at least one electrostatic panel loudspeaker for converting a panel audio signal to sound waves; a control system in communication with the at least one audio speaker and the at least one electrostatic panel loudspeaker, and configured to cause the at least one audio speaker to convert the speaker audio signal to sound waves, and cause the at least one electrostatic panel loudspeaker to convert the panel audio signal to sound waves.

The present invention provides an audio system that combines at least one traditional audio speaker with at least one electrostatic panel loudspeaker. Electrostatic panel loudspeakers are slimmer than traditional audio speakers and so the present audio system can realise a space saving compared to an audio system comprised solely of traditional audio speakers. In one configuration the at least one audio speaker may be a speaker that is configured to provide bass frequencies whereas the at least one electrostatic panel loudspeaker may be configured to provide higher audio frequencies.

Optionally, the at least one audio speaker may comprise a woofer speaker or a sub-woofer speaker.

The vehicle audio system within the vehicle may at least one vehicle seat comprising a headrest portion, wherein the at least one electrostatic loudspeaker comprises a headrest electrostatic loudspeaker unit disposed in the headrest portion. Different configurations may be used to deploy the headrest electrostatic loudspeaker unit. For example, the unit may comprise a pair of panels in the headrest either side of the occupant’s head or alternatively the unit may comprise a wraparound electrostatic panel loudspeaker. The vehicle audio system may comprise a plurality of vehicle seats, each vehicle seat comprising a headrest portion wherein each headrest portion comprises an electrostatic loudspeaker unit. The electrostatic loudspeaker units within the plurality of seats may all be of the same configuration (e.g. they may all be wraparound style panels) or there may be different configurations within the vehicle cabin (e.g. the front seats may be of the wraparound style and the rear seats may comprise a pair of panels).

The vehicle within which the vehicle audio system is deployed may comprise a front vehicle seat and the at least one electrostatic panel loudspeaker may comprise a first electrostatic loudspeaker unit and a second electrostatic loudspeaker unit within the front seat, the first electrostatic loudspeaker unit being configured to project sound forwards in the vehicle and the second electrostatic loudspeaker unit being configured to project sound rearwards in the vehicle. The first and second electrostatic loudspeaker units may be located within two different surfaces within the vehicle seat.

The vehicle within which the vehicle audio system is deployed may comprise at least one interior trim component, wherein the at least one electrostatic panel loudspeaker may be disposed within the interior trim component. The vehicle may comprise a plurality of trim components, and one or more electrostatic panel loudspeakers may be disposed within one, some or all of the plurality of trim components. The at least one electrostatic panel loudspeaker may be located within a recess within a trim component and may be located in locations traditionally occupied by traditional audio speakers.

Optionally, the vehicle audio system may comprise a plurality of electrostatic loudspeakers. The plurality of electrostatic loudspeakers may be of different sizes. Electrostatic panel loudspeakers may be configured for the deployment environment, so door panel speakers may be larger than headrest panel speakers. Electrostatic panel loudspeakers of different sizes within the vehicle audio system may also be configured to cover different frequency ranges.

Optionally, the panel audio signal may comprise a frequency range from 125Hz to 50kHz. The speaker audio signal may comprise a frequency range up to 120Hz. For sub-woofer speakers the audio signal may have a frequency range of up to 80Hz. For woofer speakers the audio signal may be in the range 60-120 Hz.

The control system may comprise one or more controllers collectively comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to: cause the at least one audio speaker to convert the speaker audio signal to sound waves and cause the at least one electrostatic panel loudspeaker to convert the panel audio signal to sound waves.

According to a further aspect of the present invention there is provided a vehicle comprising the vehicle audio system according to the above aspect of the present invention.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle with a known vehicle audio system;

FIG. 2a shows vehicle audio system in accordance with embodiments of the present invention;

FIG. 2b shows a schematic representation of the vehicle audio system of FIG. 2a;

FIG. 3 shows the control system and audio sub-system of the vehicle audio system shown in FIGS. 2a and 2b;

FIG. 4 shows the control system and electrostatic panel sub-system of the vehicle audio system shown in FIGS. 2a and 2b.

### DETAILED DESCRIPTION

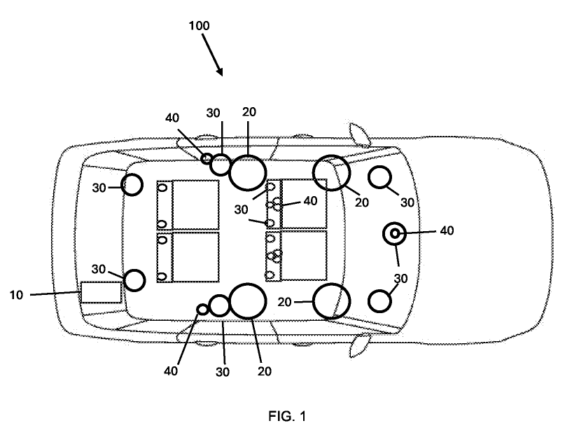

A vehicle 100 with a known vehicle audio system is shown in FIG. 1. The vehicle comprises a number of different audio speaker types including: sub-woofer 10, woofer 20, mid-range speakers 30 and tweeters 40. It is noted that in some vehicle models there may be over 30 different speakers which are controlled by a multi-channel amplifier of close to 30 different channels. In alternative vehicle configurations there may be a number of additional, smaller amplifiers distributed throughout the vehicle that are used to control the various audio speakers.

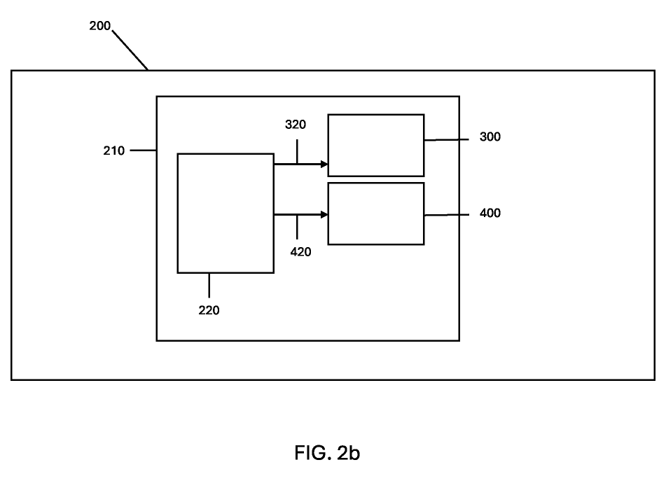

Driving such a number of speakers within an existing vehicle is a complex and power intensive process. Additionally, traditional speakers require certain space requirements to be met in order to house the components of the speaker (e.g. the magnet, coil and cone structures described below in relation to FIG. 3). In environments such as a seat headrest (note: head rests may also be referred to as seat head restraints) it may be challenging to mount all the required speakers within the vehicle structure. It is noted that front seats may contain five or more speakers. In FIG. 1 each front seat comprises multiple tweeter and mid-range speakers.

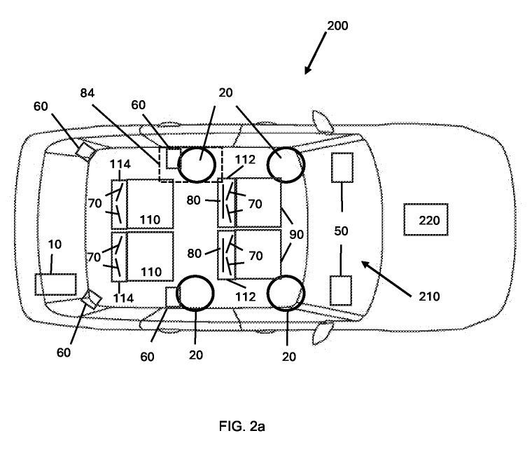

A vehicle 200 in accordance with an embodiment of the present invention is described herein with reference to the accompanying FIG. 2a. The vehicle 200 comprises a vehicle audio system 210 including a control system 220 for controlling the audio output of the speakers (10, 20, 50, 60, 70, 80) within the vehicle audio system 210.

Similarly to FIG. 1, the vehicle audio system 210 of FIG. 2a comprises a sub-woofer 10 and woofers 20. However, the mid-range and tweeter speakers of FIG. 1 have been replaced with a number of electrostatic panel loudspeakers (50, 60, 70, 80). As shown in FIG. 2, the electrostatic panel loudspeakers are of different sizes depending on their location in the vehicle.

In the configuration shown in FIG. 2a, there are two larger electrostatic panel loudspeakers 50 at the front of the vehicle. These loudspeakers 50 may have a large frequency range, e.g. 125 Hz to 50 kHz. It is noted that the electrostatic loudspeaker panels 50 may have a frequency range far beyond human auditory levels such that the impact of harmonic distortions is minimised.

Smaller electrostatic panel loudspeakers 60 may be located at the rear of the vehicle and headrest mounted electrostatic panel loudspeakers (70, 80) may be located within the headrests 112 of the vehicle front seats 90 and the headrests 114 of the vehicle rear seats 110.

In the configuration shown in FIG. 2a the rear seats 110 have two electrostatic panel loudspeakers 70 in the vehicle seat headrests 114 that direct sound forwards within the vehicle.

The headrests 112 of the front seats 90 have three electrostatic panel loudspeakers (70, 80). There are two electrostatic panel loudspeakers 70 that direct sound forwards in the vehicle and a further electrostatic loudspeaker 80 that directs sound rearwards in the vehicle towards the rear seats 110.

The electrostatic panel loudspeakers (50, 60, 70, 80) may be retrofitted to vehicles in locations that were previously occupied by traditional mid-range and tweeter audio speakers.

Electrostatic panel loudspeakers are slimmer than traditional audio speaker, e.g. they may be only 5mm in depth. Such panel loudspeakers may also therefore be located in interior trim components 84, behind material trims 84 and may also be formed into curved and other shapes such that they can be located in more locations within the vehicle cabin.

Electrostatic panel loudspeakers have a low mass diaphragm which requires a lower amount of energy to move compared to traditional audio speakers and which stops moving more quickly once the power is turned off. This may be contrasted to traditional audio speakers where the speaker cone may continue to move after power is turned off due to the cone’s higher momentum compared to the panel loudspeaker diaphragm.

Electrostatic panel loudspeakers therefore generally require lower power levels to run and provide a sharper audio experience compared to traditional speakers.

FIG. 2b shows a simplified representation of the vehicle 200 and the vehicle audio system 210 of FIG. 2a in which the control system 220 outputs a speaker audio signal 320 to an audio speaker sub-system 300 and a panel audio signal 420 to a panel sub-system 400.

In order to better understand the implementation context and advantages of the vehicle audio system 210 of the present invention, a description of an audio speaker sub-system 300 (comprising a typical woofer 20 or sub-woofer 10 audio speaker which the electrostatic panel loudspeaker (50, 60, 70, 80) is intended to be used alongside) in accordance with embodiments of the present invention is provided with reference to FIG. 3. Like features between FIG. 3 and FIGS. 1, 2a and 2b are denoted by like reference numerals.

FIG. 3 shows the control system 220 of FIG. 2a/2b connected to an audio speaker sub-system 300.

The control system 220 is further shown to comprise a vehicle audio source 305 connected to an audio amplifier 310 via a digital bus 315. The audio amplifier 310 amplifies the incoming signal from the audio source 305 and is configured to output a relatively low-voltage speaker audio signal 320 to the audio speaker sub-system 300. For clarity reasons a single audio speaker 325 is shown in FIG. 3 though it is to be appreciated that the vehicle 200 may comprise multiple audio speakers 325 in the form of one of more sub-woofer audio speakers 10 or woofer audio speakers 20. The audio signal lies in a frequency range known typically as ‘bass-range’ for audio speakers, and is typically between around 20 Hz to 200 Hz (for woofer systems) and 20 Hz up to 80 Hz for sub-woofer systems.

The audio speaker 325 provides audio transducer functionality: the audio signal 320 that is output by the audio amplifier 310 is transmitted to the audio speaker 325, which is configured to convert the incoming audio signal 320 into sound waves. More specifically, the audio speaker 325 comprises a magnet 330 and a cylindrical coil 335 of wire located between the poles of the magnet 330. The incoming audio signal 320 is transmitted through the coil 335 in alternating directions, causing the coil to move reciprocally (back and forth) between the poles of the magnet 330, based on Faraday’s law. The audio speaker 325 further comprises a speaker cone 340 that is attached to one end of the coil 335 and is therefore also driven reciprocally in time with the movements of the coil 335. As the speaker cone 340 moves, it generates pressure waves in the surrounding air which propagate and are detected by a listener as sound waves.

As noted above, the audio speaker sub-system 300 in accordance with embodiments of the present invention comprises either a woofer 20 or subwoofer 10 as the audio speaker 125.

The present Applicant has appreciated that other types of transducers exist which can generate sound waves and hence function as speakers. For example, electrostatic transducers may be used in a speaker system to generate audio waves in addition to the audio speaker 325 described above. As the technically skilled person would be aware, electrostatic transducers in their most general sense are designed to generate sound via a force exerted on a membrane (or diaphragm) that is suspended in an electrostatic field. In more detail, electrostatic transducers typically comprise a membrane (e.g., a flexible sheet coated in an electrically conductive material) that is sandwiched between two electrically conductive stators (or grids), leaving a small air gap on either side of the membrane. The incoming audio signal is used to drive the stators, resulting in the generation of an electrostatic field proportional to the audio signal between the stators. The membrane is charged and held at a high voltage relative to the stators. A force is thus exerted upon the membrane causing it to move, driving the air on either side of the membrane to generate pressure waves (sound waves).

The present Applicant has appreciated that there are multiple benefits associated with the use of electrostatic transducers (e.g., improved audio response and sound quality obtained, improved versatility of implementation), and that it would be useful to combine the vehicle audio sub-system 300 described above (comprising one or more audio speakers 325) for bass response with an electrostatic speaker system for mid-range and high-frequency ranges.

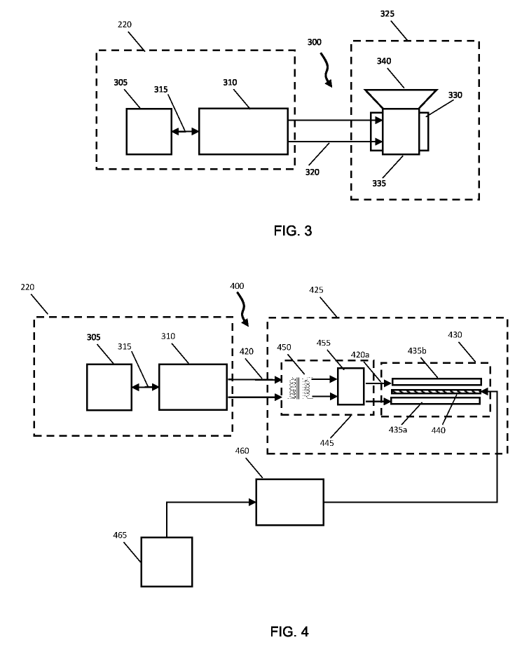

An electrostatic loudspeaker panel in accordance with embodiments of the present invention is now described with reference to FIG. 4. Like features between FIG. 4 and FIGS. 1, 2a, 2b and 3 are denoted by like reference numerals.

FIG. 4 shows the control system 220 of FIG. 2a/2b connected to an electrostatic panel loudspeaker sub-system 400.

As also shown in FIG. 3, the control system 220 comprises the vehicle audio source 305 connected to the audio amplifier 310 via the digital bus 315. As shown in FIG. 4, the audio amplifier 310 is also configured to amplify the incoming signal from the audio source 305 and output a relatively low-voltage panel audio signal 420 to the electrostatic panel loudspeaker sub-system 400. For clarity reasons a single electrostatic panel loudspeaker 425 is shown in FIG. 4 though it is to be appreciated that the vehicle 200 may comprise multiple panel speakers 425 in a variety of locations within the vehicle as shown in FIG. 2a.

It is noted that the electrostatic panel loudspeaker 425 shown in FIG. 4 corresponds to the electrostatic panel loudspeakers (50, 60, 70, 80) shown in FIG. 2.

It is further noted that the components audio source 305, audio amplifier 310 and digital bus 315 are the same as described previously with reference to FIG. 3. The output panel audio signal 420 corresponds to the audio signal 320 output in FIG. 3, the speaker audio signal 320 being directed to the audio speaker 325 and the panel audio signal 420 being directed to an electrostatic panel loudspeaker 425.

The electrostatic loudspeaker sub-system 400 comprises the electrostatic panel loudspeaker 425 which provides transducer functionality. Specifically, the electrostatic panel loudspeaker 425 comprises an electrostatic transducer 430 that is configured to convert the panel audio signal 420 that is output by the audio amplifier 310 into sound waves. In more detail, the electrostatic transducer 430 comprises a pair of stators 435a, 435b and a membrane 440 that is located between the pair of stators 435a, 435b. The stators 435a, 435b are configured to receive an incoming audio signal 320 and generate an electrostatic field; and the membrane 440 is configured to move within the electrostatic field and create sound waves.

Additionally, the electrostatic panel loudspeaker 425 further comprises a voltage conversion module 445 that is configured to receive the panel audio signal 420 output by the audio amplifier 310, and to convert this input signal (which as previously mentioned corresponds to a relatively low-voltage speaker level signal) into a relatively high-voltage audio signal 420a that can be used by the stators 435a, 435b to generate an electrostatic field of sufficient strength to move the membrane 440.

In order to perform its functionality, the voltage conversion module 445 comprises at least one audio transformer 450 (i.e., a transformer that is of audio quality) that is configured to ‘step-up’ the voltage of the incoming audio signal 420 to a predefined voltage level that is suitable for operating the electrostatic transducer 430 (and specifically the stators 435a, 435b) in the desired manner. This predefined voltage value is typically of the order of several hundred V (for example, between around 500 V to 700 V etc.); in particular instances it is between around 550 and 650 V, and more particularly is around 600 V. The transformer 450 that is used in the voltage conversion module 445 may correspond to any suitable transformer that is of audio-quality and capable of providing the necessary step-up functionality for the audio signals. In one specific example, the transformer 450 may be implemented as a toroidal transformer. Advantages associated with the use of such a transformer – such as high efficiency and small size – render it particularly suitable for use in the context of the electrostatic panel loudspeaker 425.

Advantageously, the use of an audio transformer in the voltage conversion module 445 to provide the desired step-up of voltage for the signal utilises a simple and straightforward solution that optimises the desired outcome, whilst minimising the additional number of electronics components that are required to be installed. As such, the physical size of the voltage conversion module 445 is minimised overall, which is useful as this module needs to be installed in close physical proximity to the electrostatic transducer 430 in order to provide the necessary functionality. As a result, the voltage conversion module 445 can be combined with the electrostatic transducer 430 without unduly increasing the size of the electrostatic panel loudspeaker 425 as a whole. This is particularly advantageous when replacing speaker systems installed in locations within vehicles where space may be limited.

Additional electronic (processing) components may also be provided as part of the electrostatic panel loudspeaker 425, such as smoothing components 455 that are configured to perform signal smoothing on the stepped-up signal prior to its input to the electrostatic transducer 430. Although these smoothing components are shown in FIG. 4 as forming part of the voltage conversion module 445, they may instead be provided as a separate module entirely.

As noted previously, for an electrostatic transducer to be operated correctly, the membrane that is located between the stators needs to be charged to a high potential (voltage). As such, the vehicle audio system 210 further comprises a high voltage module 460 that is configured to provide the necessary high voltage power to charge the membrane 440 in the electrostatic transducer 430. The high voltage module 460 is, in essence, a small voltage conversion module (box) that can convert an input low voltage (12V) to a significantly higher output voltage. The high voltage module 460 can be installed in a variety of different locations within the vehicle having an appropriately sized space, for example in the loadspace area. The appropriate level of power that this high voltage module 460 provides is typically in the order of several thousand Volts (for example, between around 2 kV and 5 kV etc.); in particular instances it is between 2.5 kV and 4kV, more particularly between 2kV and 3kV, and still more particularly is around 3 kV.

A power source 465, for providing the appropriate power to the high voltage module 460, also forms part of the vehicle audio system 400. This power source 465 may correspond to the standard (vehicle) battery that is used to power other components of the vehicle in which the audio system 400 is to be installed. As a result, the vehicle audio system 400 can seamlessly integrate (and be retrofit) into the existing vehicle systems despite the differing requirements in power and signal strength of the electrostatic speaker system 425 relative to the standard audio system 325.

It will be appreciated that various changes and modifications can be made to the present invention without departing from the scope of the present application.

What is claimed is:

1. A vehicle audio system for a vehicle comprising:
at least one audio speaker for converting a speaker audio signal to sound waves;
at least one electrostatic panel loudspeaker for converting a panel audio signal to sound waves; and
a control system in communication with the at least one audio speaker and the at least one electrostatic panel loudspeaker, and configured to cause the at least one audio speaker to convert the speaker audio signal to sound waves, and cause the at least one electrostatic panel loudspeaker to convert the panel audio signal to sound waves.

2. A vehicle audio system as claimed in claim 1, wherein the at least one audio speaker comprises a woofer speaker.

3. A vehicle audio system as claimed in claim 1, wherein the at least one audio speaker comprises a sub-woofer speaker.

4. A vehicle audio system according to claim 1, comprising at least one vehicle seat comprising a headrest portion, wherein the at least one electrostatic loudspeaker comprises a headrest electrostatic loudspeaker unit disposed in the headrest portion.

5. A vehicle audio system according to claim 4, comprising a plurality of vehicle seats, each vehicle seat comprising a headrest portion wherein each headrest portion comprises an electrostatic loudspeaker unit.

6. A vehicle audio system according to claim 4, comprising a front vehicle seat wherein the at least one electrostatic panel loudspeaker comprises a first electrostatic loudspeaker unit and a second electrostatic loudspeaker unit within the front seat, the first electrostatic loudspeaker unit configured to project sound forwards in the vehicle and the second electrostatic loudspeaker unit configured to project sound rearwards in the vehicle.

7. A vehicle audio system as claimed claim 1, comprising at least one interior trim component, wherein the at least one electrostatic loudspeaker is disposed within the interior trim component.

8. A vehicle audio system as claimed in claim 1, comprising a plurality of electrostatic loudspeakers.

9. A vehicle audio system as claimed in claim 8, wherein the plurality of electrostatic loudspeakers are of different sizes.

10. A vehicle audio system as claimed claim 1, wherein the panel audio signal comprises a frequency range from 125Hz to 50kHz.

11. A vehicle comprising the vehicle audio system according to claim 1.
